(19) United States
(12) Patent Application Publication
(10) Pub. No.: US 2017/0364998 A1
(43) Pub. Date: Dec. 21, 2017

(54) User Instruction Module

(71) Applicants: Stock Forecasting International, Buffalo Grove, IL (US); Superdome, LLC, Buffalo Grove, IL (US)

(72) Inventors: Arkady Rivtis, Buffalo Grove, IL (US); Pavel Kovalenko, Buffalo Grove, IL (US); Vlad Karpel, Buffalo Grove, IL (US); Alex Benyukhis, Buffalo Grove, IL (US)

(73) Assignees: Stock Forecasting International, Buffalo Grove, IL (US); Superdome, LLC, Buffalo Grove, IL (US)

(21) Appl. No.: 15/187,342

(22) Filed: Jun. 20, 2016

(51) Int. Cl. G06Q 40/04

(52) U.S. Cl. CPC G06Q 40/04

(57) ABSTRACT

An improved stock ranking and trading decision support system and method employ analytical prediction and prediction verification to identify assets for purchase. The disclosed system and techniques use a harmonic component forecasting model, artificial band-pass digital filters, and logical representations of wave time series and neural network processes to identify the profitable companies for investment as well as the likely direction of movement of the asset future value. The system compares, optimizes and tests the price of the asset at a given point in time in order to predict the trading decision support model and estimate potential profit.

### TECHNICAL FIELD

The present disclosure is related generally to valuation and, more particularly, to a system and method for providing guidance regarding the usability of stock valuation.

### BACKGROUND

Individuals who wish to sell or acquire a product are interested in knowing what the price of that product will be at a later time. For example, the individual does not want to buy the product at a high price today only to see the price drop tomorrow, nor would it be desirable to sell a product for a low price today, only to see the going price increase dramatically the next day. This is true of cars, planes, buildings and crops, and is also true of financial assets and instruments. In all cases, people want to know that they are not selling too low or buying too high.

The stock market is an example of a field in which prices rise and fall frequently, and thus wherein users seek to understand the future value of an asset. Unfortunately, none of us are able to time travel, and without it, the stock analysis field is dominated by non-periodical data intensity, unstructured noise and unknown relationships. The popular forecasting methods usually use simple models, i.e., “trend+noise” models, in combination with recurrent parameters in identification algorithms. However, in econometric forecasting, real time series have a more complex structure, perhaps including non-periodic oscillating time series and as a result, prediction of the stock market is not a simple task.

In the field of stock market fundamentals and technical analyses, it is possible to employ time series prediction methods that are autoregressive integrated moving average and generalized autoregressive conditional methods. However, as the names would imply, these methods are difficult to deal with for nonlinear features, especially for identifying and forecasting non-periodic time series with wave structure.

While the present disclosure is directed to a system that can eliminate certain shortcomings noted in or apparent from this Background section, it should be appreciated that such a benefit is neither a limitation on the scope of the disclosed principles nor of the attached claims, except to the extent expressly noted in the claims. Additionally, the discussion of technology in this Background section is reflective of the inventor's' own observations, considerations, thoughts, and is in no way intended to accurately catalog or comprehensively summarize the art currently in the public domain. As such, the inventors expressly disclaim this section as admitted or assumed prior art. Moreover, the identification herein of a desirable course of action reflects the inventor's' own observations and ideas, and should not be assumed to indicate an art-recognized desirability.

### SUMMARY

The described system for asset ranking and trading decision support avoids the limitations of well-known prediction models and provides improved accuracy in asset value movement prediction as a result. In general, neural network technology suffers from the large number of parameters to fix and the scarce prior user knowledge regarding the relevance of the inputs in the situation.

In the disclosed system and method, free parameters are selected in such a way that the regression obtained by neural network techniques is robust against “noisy” conditions and influence of the free parameter's values in the recursive function. In an embodiment, the primary criteria for optimum selection and ranking of companies is the selected company's stock price versus time trends, which are described by the forecasting system and method with high accuracy. Companies that have a forecasting accuracy level above a certain threshold are selected as a subset of “best” options, since they satisfy the criteria described above, and these best options are recommended to the user to form the portfolio for potentially profitable trade based on a forecasting stocks value.

In a further embodiment, discrete smoothing and differentiation methods are used to avoid prediction model limitations. The least squares support algorithm may be used for optimization of a regularized function with equality constraints to obtain an optimal solution.

Further, a digital non-recursive and band-pass neural network filter may be used for harmonic component extraction to aid regression. Of special interest with respect to stocks having high amplitude fluctuations in stock price, amplitude and frequency parameters are selected for stock price prediction time-series.

In an embodiment, the disclosed system and method also includes identification of non-periodic forecasting models for short or long term forecasting period, buy-sell-hold customer supporting decision recommendation, and a profit calculator. The method and system automatically simulate trade with a specific initial investment amount and then test the analytical trading strategies against the company's actual history. The analytical analysis of the stocks wave patterns results in a recommendation of the companies with the greatest profit expectation, e.g., for the S&P 500 or other collection. A forecasting accuracy analyzer parses the accumulated record of statistical difference between the predicted price on a trade and the actual fill price and estimates forecasting error.

Other features and aspects of embodiments of the disclosed principles will be appreciated from the detailed disclosure taken in conjunction with the included figures.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a flow diagram showing an exemplary process of asset price forecasting in accordance with an embodiment of the disclosed principles;

FIG. 2 is a flow diagram showing an exemplary process of stock ranking and trading decision support in accordance with an embodiment of the disclosed principles;

FIG. 3 is a component-level schematic showing the use of digital non-recursive filters to identify unknown stocks price frequency components and reduce “noise” influence in accordance with an embodiment of the disclosed principles;

FIG. 4 is a component-level schematic showing a cascade of artificial neural network filters to identify unknown stocks forecasting parameters matrix-outputs in accordance with an embodiment of the disclosed principles;

FIG. 5 is a decision tree showing the effect of the algorithm for testing absolute error and relative error in actual and predicted stock price in accordance with an embodiment of the disclosed principles; and

FIG. 6 is a decision tree showing the calculation of a ranking coefficient in accordance with an embodiment of the disclosed principles.

### DETAILED DESCRIPTION

With this overview in mind, and turning now to a more detailed discussion in conjunction with the attached figures, the techniques of the present disclosure are illustrated as being implemented in a computing device such as a PC, laptop, tablet, smartphone or other device capable of executing computer-executed instructions stored on a non-transient medium, e.g., memory, such as RAM, ROM, EPROM, flash memory and so on. Thus, the execution of steps in a process flow is by way of computer-execution of such steps, e.g., via a processor configured to retrieve the corresponding instructions from memory and execute them.

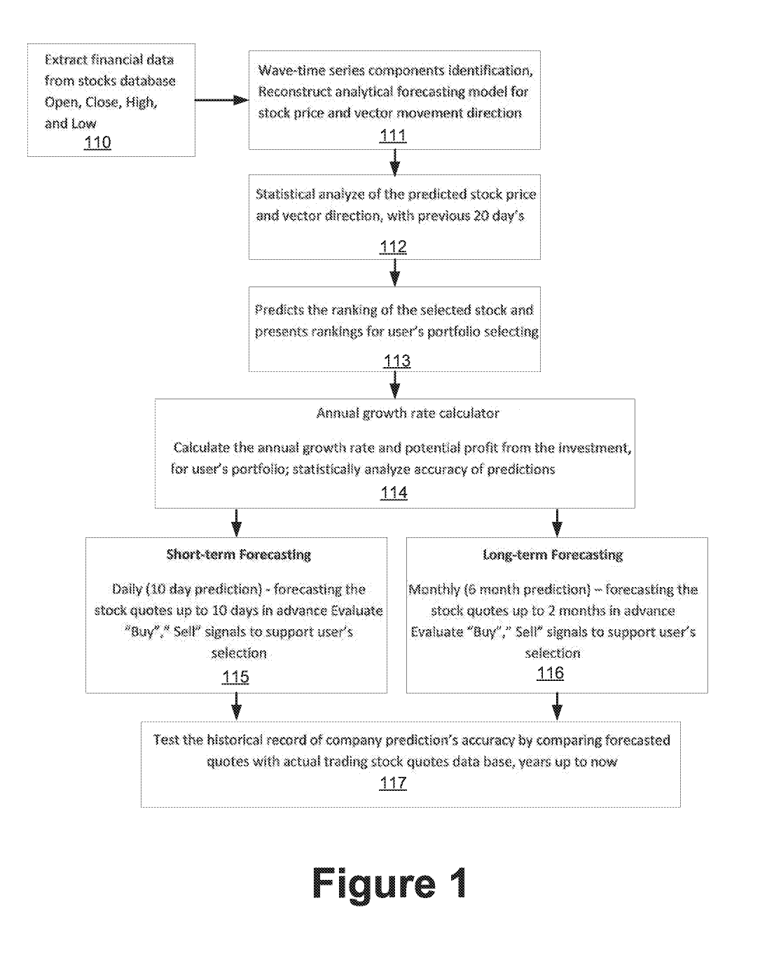

The creation of a user portfolio is shown in FIG. 1 via process 100. Initially at stage 110, data is extracted from a stocks database, including a certain amount, e.g., up to 300 days, of historical open, close, high and low stock price values for a given stock group such as the S&P 500. The user can alternatively create his or her own personal portfolio and include this group or selected stocks in the database.

At stage 111, the device identifies wave-time series components and reconstructs an analytical forecasting model for stock price and movement direction. The supportive technologies, e.g., as listed above, then compute frequencies and magnitudes of the non-periodical time-series stocks price forecasting harmonics to compare and optimize the final forecasting model. The trading decision support is considered and the direction in which the observed price of an asset moves will be forecast.

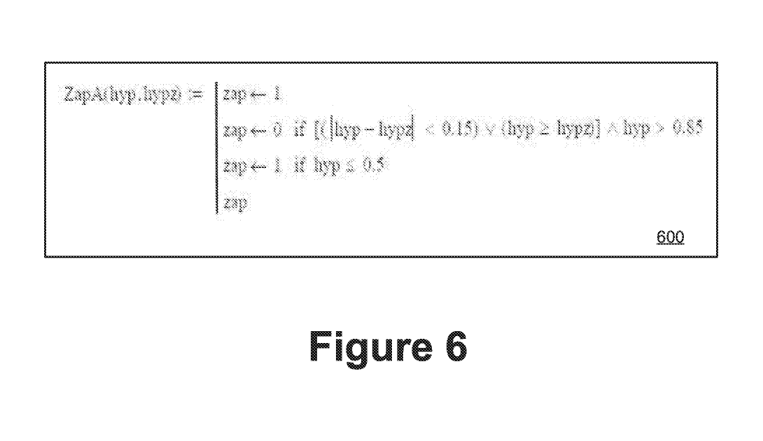

The system statistically analyzes the predicted stock price and vector direction against the data for an historical window, e.g., the prior 20 days, at stage 112. In particular, the system evaluates the coefficient of the price-vector accuracy prediction and relative error in actual and predicted stock price for trading day “N”, compared to the previous trading day “N−1”. The primary goal of this method is to identify companies with the highest ranking coefficient ZapA(hyp, hypz) (see FIG. 6) and recommend this group of companies to the user as the most profitable for the next day's investment.

Subsequently at stage 113, the system predicts the ranking of the selected stock and presents rankings for the user's portfolio selections. The statistical analysis of the predicted stock price and vector direction will create the ranking chart for selecting the “Best” companies to trade at the “next” trading session. The companies selected (“GOOD” company), e.g., those approaching a ranking coefficient ZapA>0.85 or more may be recommended for the next business day trading with the highest possible prediction accuracy. In other words, the system attempts to select only companies with proven high level next-day prediction accuracy.

In an embodiment, an annual growth rate is calculated at stage 114. In particular, the expected annual growth rate and potential profit from the investment are calculated for the user's portfolio and the accuracy of predictions is statistically analyzed. The profit calculator will analyze the stock forecasting trend of the chosen company to make a decision (Buy, Hold or Sell) according to predicted trading signals, accumulate “Profit/Lost” for 300 days of simulated daily “virtual trade” and compute the “Annual Growth Rate.” The company stock price trends, turning points, movement direction and “Buy-Hold-Sell” signals are then calculated. (FIG. 1, step 15, 16).

With respect to forecasting short term and long term stock price trends the system computes the frequencies and magnitudes of the non-periodical time-series stock price forecasting harmonics, compares and optimizes the final forecasting model. The trading decision support is considered and the direction in which the observed price of an asset moving will forecast. With respect to short-term trends, this is seen in stage 115, with daily forecasting, and a forecast up to 10 days in advance. With respect to long-term investing, this is shown in stage 116. For monthly forecasting, the system forecasts the stock quotes up to 6 months in advance.

Using the forecasted data, a decision rule is created. The decision to “buy” or “sell” is accepted if the estimated local minimum or maximum is located near the current day respectively. The decision “hold” is accepted in any other cases. At stage 117, the historical record of company prediction accuracy is tested by comparing forecasted quotes with actual historical stock quotes data base.

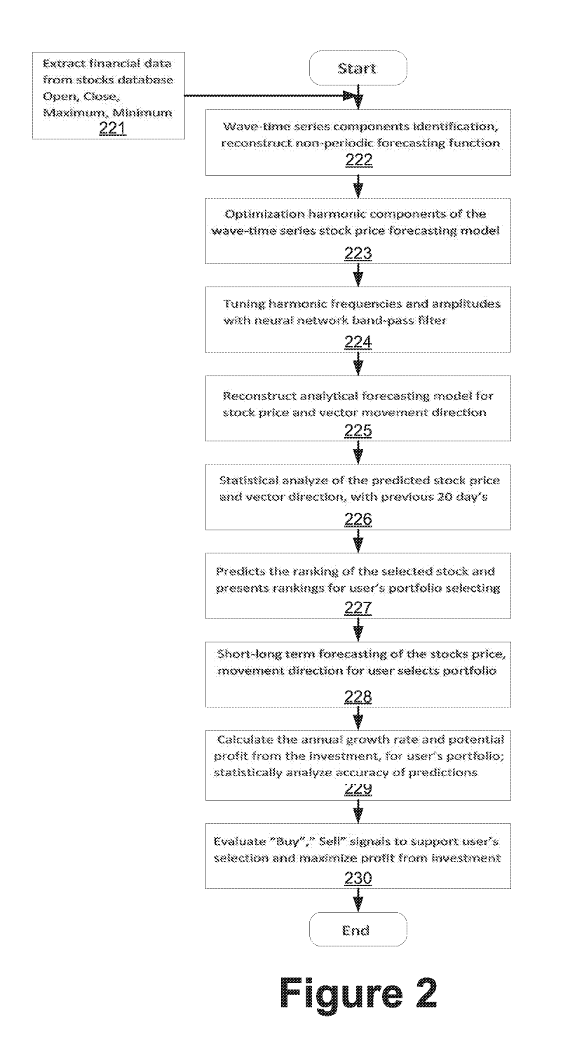

Turning to FIG. 2, this figure shows a flow diagram of an exemplary process of stock ranking and trading decision support in accordance with an embodiment of the disclosed principles. The extraction of the open, close, high and low stocks price values from the historical S&P 500 data base and from the 300 days matrix is shown in stage 221 for calculating predicted price as a function of the frequencies, amplitudes and time variables for the observed companies. The wave-time series components are identified, and the non-periodic forecasting function is reconstructed at stage 222.

The harmonic components of the wave-time series stock price forecasting model are optimized at stage 223. In particular, wave-time components for the non-periodical forecasting model are identified and reconstructed. The forecasting model in an embodiment is in the form of a Discrete Fourier Transformation (DFT) Yₖ below, with unknown frequencies, amplitudes and recurring parameter.

$${Y}_{k} = {\sum }_{i = 0}^{n} {D}_{i} {k}^{i} + {\sum }_{j = 0}^{m - 1} [ {A}_{j} cos {ω}_{j} k + {B}_{j} sin {ω}_{j} k ] + {ξ}_{k} \qquad ( 1 )$$

where Yₖ—the non-periodic time series value at instant k, recurring parameters Dᵢ, Aⱼ, Bⱼ, n—the degree of polynomial component, m—number of harmonics with frequencies ωⱼ, ξₖ—“trend+noise”.

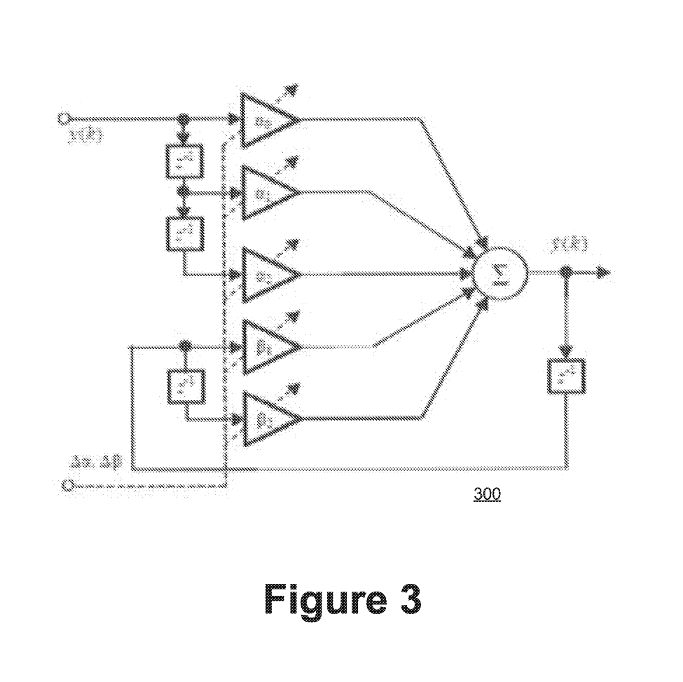

As shown in FIG. 3 and in stage 224 of FIG. 2, the digital non-recursive filters are used to identify unknown stock price frequency components and reduce “noise” influence. To calculate unknown amplitudes and frequencies for forecasting model Yₖ (1), the discrete smoothing and differentiation methods are used, based on a low-pass filter and exponential smoothing algorithm (2).

Y̅ₖ^{s}=αₛY̅ₖ₋₁^{s}+(1−αₛ)Yₖ,0<αₛ<1, (2)

In smoothing, the initial time series (1) can be divided into the slow component trend Y̅ₖ^{s} and the fast trend, \tilde{Y}ₖ=Yₖ−Y̅ₖ^{s} which are the linear transformation of the wave component distorted by random noise ξₖ.

The smoothing transformation does not change the wave component spectrum apply the high order exponential smoothing and leads to the modification of the non-periodic, trend-seasonal time forecasting model (1) in simpler form:

$${y}_{k} = {\sum }_{j = 0}^{m - 1} [ {a}_{j} cos {ω}_{j} k + {b}_{j} sin {ω}_{j} k ] + {ζ}_{k} . \qquad ( 3 )$$

The inverse transformations of the equations (2, 3) can be represented in the linear auto-regression form for identification of the recurring components.

Next is identification the group of frequencies and amplitudes likely to influence the observed prices of an asset. The trend extraction is performed by discrete differentiation of time series (1), which is previously smoothed by discrete wide-band filter in the purpose of noise reduction:

\tilde{Y}ₖ^{d}=α_{d}\tilde{Y}ₖ₋₁^{d}+(1−α_{d})Yₖ,0<α_{d}<1,

Vₖ=\tilde{Y}ₖ^{d}−\tilde{Y}ₖ₋₁^{d}=(1−α_{d})(Yₖ−\tilde{Y}ₖ₋₁^{d}) (4)

The parameter identification criterion can be obtained via the recurrent quadratic algorithm [3]:

$$J = {\sum }_{k = 2 m}^{N - 1} {[ {y}_{k} + {y}_{k - 2 m} - {β}^{T} y ( k \cdot m ) ]}^{2} \qquad ( 5 )$$

The tuning parameters and unknown frequencies ωⱼ are connected with the estimated parameters Bⱼ by the equation:

$${β}_{0} + {\sum }_{j = 1}^{m - 1} {β}_{j} cos j ω = cos m ω \qquad ( 6 )$$

The unknown frequencies ωⱼ may be determined as roots of the power polynomial from the argument cos(ωⱼ) and filtered through the low-pass filter realized by the exponential algorithm.

The optimization of harmonic components and recurring parameters Dᵢ, Aⱼ, Bⱼ, ωⱼ of the wave-time series stock price forecasting model (1) are executed in stage 223 as noted above. To optimize forecasting parameters to calculate the wave components, the following linear optimization is used:

ŷₖ₊ₚ=\hat{β}ₖ^{T}ŷ(k+p,m)−yₖ₊ₚ₋₂ₘp≧1,

Ŷₖ₊ₚ=Y̅ₖ₊ₚ^{s}+\tilde{Y}ₖ₊ₚ (7)

where, Y̅ₖ₊ₚ^{s} is a trend component and \tilde{Y}ₖ₊ₚ is a wave component's forecast.

As a result the non-periodic wave time series forecasting formula (7) may be represented as:

$${\overline{Y}}_{k + p} = {\tilde{Y}}_{k}^{d} + {\sum }_{i = 1}^{p} {\overline{V}}_{k + i} + \frac{{α}_{d}}{1 - {α}_{d}} {\overline{V}}_{k + p} . \qquad ( 8 )$$

In real non-periodic wave-time series the harmonic components are mixed with a high frequency noise, and digital processing will amplify and suppress the original signal.

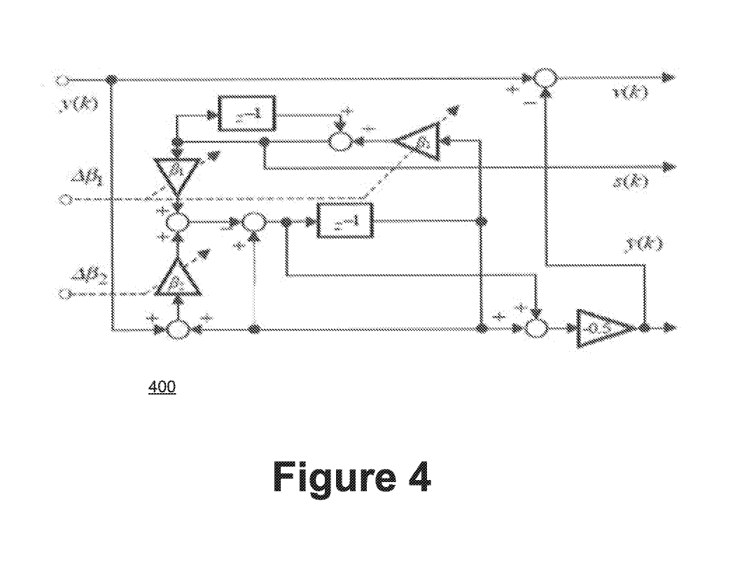

As noted above, the harmonic frequencies and amplitudes are tuned at stage 224 via the neural network band-pass filter. The digital non-recursive filters are used in harmonic component extraction of the stochastic time series [4]. Here, we are using discrete wide-band filtering as shown in FIG. 3 to extract unknown stock price frequency components ω₁, ω₂, . . . ωₘ and reduce “noise” influence. Then the cascade of the artificial neural network filters (FIG. 4) identifies matrix-outputs y1(k), y2(k), . . . , ym(k).

The chain of artificial neural network band-pass digital filters (FIG. 3-4) are used to identify frequencies and amplitudes of partial harmonics and reconstruct non-periodic stock price time series (1).

The magnitudes of stocks price time-series forecasting harmonics are determent in matrix Y (k,m):

$$Y ( k , m ) = [ \begin{matrix}{y}_{2 m} \\ {y}_{2 m - 1} \\ ⋮ \\ {y}_{k}\end{matrix} ] . \qquad ( 9 )$$

The solutions of optimized frequencies ω₁, ω₂, . . . ωₘ from digital filtration (FIG. 3) and magnitude matrix Y(k,m) are combined to yield a final reconstruction model for stock price function (1).

At stage 226, the predicted stock price and vector direction are statistically analyzed with the prior 20 day's data. In an embodiment, the method entails calculation of the statistical evaluation coefficient “hyp” which includes the probability of the price-vector accuracy prediction and relative error ε % in actual and predicted stock price for the trading day compared to the previous trading day “N−1”.

The probability of the price-vector accuracy prediction is evaluates as sign(x):

$$sign ( x ) = \{ \begin{matrix}0 , x = 0 , \\ 1 , x > 0 , \\ - 1 , x < 0\end{matrix} . \qquad ( 10 )$$

where, Yₖ close price for day k, Ŷₖ—close predicted price for day k;

dYₖ=Yₖ=Yₖ₋₁,dŶₖ=Ŷₖ−Yₖ₋₁,k=2̅,̅N̅,dŶzₖ=Ŷₖ₊₁−Yₖ₋₁,

sYₖ=sign(dYₖ),sŶₖ=sign(dŶₖ),sŶzₖ=sign(dŶzₖ) (11)

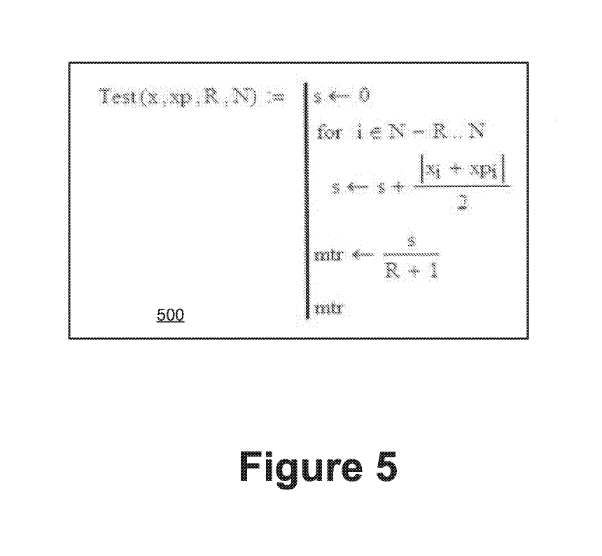

The absolute and relative error between the actual and predicted stock prices for trading day is analyzed, compared to the prior trading session. The ranking of the selected stock is calculated and rankings are presented for the user's portfolio selection at stage 227. In this connection, FIG. 6 shows the decision tree for calculations of the ranking coefficient ZapA. The algorithm for testing absolute and relative error in actual and predicted stock price for trading day comparing to the previous trading day “N−1” (Test(x,xp,R,N)) is shown in FIG. 5. The calculations of the ranking coefficient ZapA(hyp, hypz) include the algorithms Test(x, xp, n) (3.1) and SignN(hyp,hypz) (3.2). ZapA(hyp, hypz) is a probability to get NEXT day prediction correct and can be calculated by the algorithm shown in FIG. 6.

In an embodiment, the condition for “GOOD” companies is: hyp>N (An embodiment uses N=0.85 or 85% of the “combine” statistical accuracy, but it is a user's choice to make changes with hyp in the range 0.5<hyp<1). The main goal is to find companies with the highest ranking coefficient ZapA(hyp, hypz) and recommend this group of companies to the user as the most profitable for next day investment. The forecasting model (1) calculated for companies with ZapA(hyp, hypz) between 0.85 and 1.00 is the most accurate for nest day stock price prediction. The companies selected that meet (or, in an embodiment, approach) a level of hyp>0.85 or more can be recommended for the next business day trading with the highest possible prediction accuracy. Thus, the disclosed method helps users select only the group of companies with proven high level accuracy of the predictions for the close stocks price for the next day trading session. Of course all calculations can be automatically repeated for High and Low stock price

The short-long term forecasting of the stock price and movement direction for the user-selected portfolio is executed at stage 228. The present stock ranking and trading decision support allows the user to attain information from a historical set of data (stage 221), find a mathematical pattern in stock price forecasting model (stages 222-225), and statistically analyze and rank companies with highest accuracy of the stock's price forecasting (stages 226-227). The disclosed method includes forecasting stock price for selecting ranking by algorithm (FIG. 6) of companies chosen by user for a short (up to 10 days in advance) or long term (up to 6 month in advance) forecast (FIG. 2, step 228).

The annual growth rate and potential profit from the investment are calculated for user's portfolio, and the accuracy of predictions is statistically analyzed at stage 229. In an embodiment, a Profit Calculator shows what the hypothetical profits might have been if one had traded by using the present forecasting technology. The Profit Calculator is automatic and simulates virtual trade with a specific initial investment amount and then tests the analytical trading strategies against company actual historical data base. The Profit Calculator is a “virtual analytical trader,” an algorithm with dynamic characteristics:—“Buy” at minimum point of forecasting trend, “Sell”—at maximum point of forecasting trend—“Take Profit”—sell if stock price moves up 2% and—“Stop Losses”—sell if prediction was directed wrong and stock actually lost 10% of initial value and goes down instead of up. The Profit Calculator analyzes the stock forecasting trend of the chosen company to make a decision: Buy, Hold or Sell; according to predicted trading signals, accumulate “Profit/Lost” for 300 days of simulated daily “virtual trade” and computes the “Annual Growth Rate”.

The company stock price trends, turning points and movement direction are predicted and “Buy”, “Sell” signals are evaluated to support the user's selection and maximize profit from investment at stage 230. Using the forecasted data, the decision rule is created. The decisions to “buy” or “sell” is accepted if the estimated local minimum or maximum is located near the current day respectively. The decision “hold” is accepted in any other cases. Short and long-term forecast of stock prices and detection of the ‘state for decision’ or every company from the “perspective” set:—“buy” if the stock price is near the local minimum in current time and predicted price will forecast as increases;—“sell” if the stock price is near the local maximum and the predicted price estimates as decreases;—“hold” if the stock price is “stable” and not fluctuating significantly from the statistical average.

In conclusion, the disclosed principles provide for the forecasting of financial non-periodic time series with fluctuating wave structure. The method allows a computer to attain information from a historical set of data, find a mathematical pattern, rank the stocks and predict stock price trends for short or long time periods. In an embodiment, the implementing software includes features than support the user's trading decision and insure a profitable investment strategy.

### EXAMPLE

The disclosed stock ranking and trading decision support method is based on the study of the stock's history and the usage of novel methodology and intelligent techniques to predict stock price time-series, while having an easy-to-use interface, high algorithmic speed, and better accuracy than other predictive techniques.

This example includes step by step description and explanation only for S&P 500 companies close stock price; however, it can be used for any groups of companies and industries selected be the user.

The disclosed method of stock ranking and trading decision support includes a supportive algorithm configured to generate and reconstruct a predictive analytical model for a stock's price and vector movement direction as a function of time.

This entails processing historical stock price data over a specific time period in order to obtain a formula for calculating predicted price for an asset as a function of the frequencies, amplitudes and time variables of the observed companies.

In addition, the group of frequencies and amplitudes that are likely to influence the observed prices of an asset are identified and optimization parameters are calculated for the formula using an input set of observed variables at given points in time, digitally filtering the optimized variables, and reconstructing the formula for stock price value versus time.

As an example, we are using company APC's closing price data to generate and reconstruct a predictive analytical model for its stock price and vector movement direction as a function of time.

The first step is to extract over 400 days of the stock's close price values and then to identify and reconstruct wave-time components for the non-periodical forecasting model for APC:

$${Y}_{k} = {\sum }_{i = 0}^{n} {D}_{i} {k}^{i} + {\sum }_{j = 0}^{m - 1} [ {A}_{j} cos {ω}_{j} k + {B}_{j} sin {ω}_{j} k ] + {ξ}_{k} \qquad ( 1 )$$

The next steps include optimization of the harmonic components for the forecasting model (1), tuning harmonic frequencies and amplitudes: Di, Aj, B j, ω j; with a neural network band-pass filter and then final analytical reconstruction of the forecasting model for stock price and vector movement direction as a function of time.

The next steps involve a calculation of the predicted close stock price values for 20 days prior to “today” and statistically comparing the actual historical value with the predicted value.

The function is used to predict the vector direction. After final reconstruction, we look at the company's data from twenty days prior and compare the real vector direction to our predicted vector direction. If the company's vector direction matches or exceeds our predicted vector direction, then a new graph is constructed and denoted with a +1.

If the company's vector direction is less than our predicted vector direction, then another new graph is constructed and denoted with a −1.

dYₖ=Yₖ−Yₖ₋₁,dŶₖ=Ŷₖ−Yₖ₋₁(dYp),

k=2̅,̅N̅,dŶzₖ=Ŷₖ₊₁−Yₖ₋₁(dYpz),k=2̅,̅N̅−̅1̅ (2)

Then using a statistical function, we calculate a value for the percent error in order to show the accuracy of the predicted vector directions.

A statistical analysis of the stock's vector movement direction is then performed for the 20 days prior to today.

$${sY}_{k} = sign ( {dY}_{k} ) , s {\hat{Y}}_{k} = sign ( d {\hat{Y}}_{k} ) , s \hat{Y} {z}_{k} = sign ( d \hat{Y} {z}_{k} )$$

$$Where \text{:}$$

$$sign ( x ) = \{ \begin{matrix}0 , x = 0 , \\ 1 , x > 0 , \\ - 1 , x < 0\end{matrix} .$$

The final calculation of the relative accuracy of the stocks vector movement direction for 20 days prior to “today” is equal to 96.9%:

$$\frac{1 \cdot 1 + 1 \cdot \frac{1}{3} + 1 \cdot \frac{1}{5} + 0.7 \cdot \frac{1}{10} + 0.667 \cdot \frac{1}{15}}{1 + \frac{1}{3} + \frac{1}{5} + \frac{1}{10} + \frac{1}{15}} = \frac{1.65}{1.7} = 0.969$$

The high level of the accuracy for the stock's vector movement direction predictions (20 days prior to “today”) for ACP Company, automatically lead the forecasting algorithm to evaluation statistical accuracy for absolute and relative error in comparing predicted value for stock price and actual.

In the disclosed method of stock ranking and trading decision support we designed a test procedure Test(x,xp,R,N) to evaluate statistical absolute and relative errors.

$$\begin{matrix}Test ( x , xp , R , N ) := \\ \begin{matrix} \\ \\ \\ \end{matrix} \\ \end{matrix} \vert \begin{matrix}s ← 0 \\ for i ∈ N - R … N \\ s ← s + \frac{\vert xi + xpi \vert}{2} \\ mtr ← \frac{s}{R + 1} \\ mtr\end{matrix}$$

$${ɛ}_{\%} = \frac{\vert 39.09 - 37.67 \vert}{39.09} \cdot 100 \% = 3.64 \% , \\ {ɛ}_{\$} = \vert 39.09 - 37.67 \vert = 1.42 \$$$

The scientifically high accuracy for 20th consecutive trading sessions in prediction for stock price movement directions and closing stock prices lead us to conclusion that the company APC can be selected as high ranking for trading in next business session, using new invented method of the stock ranking and trading decision support.

The ranking of the selected stock is calculated and presented for the user's portfolio selection. The disclosed method will analyze S&P 500 companies and recommended groups of selected companies to the user. This gives the user mathematically proved selections to form a portfolio and make a profitable investment for the next business day.

In the next steps, the user can test the selected stocks and calculate the annual growth rate and potential profit from the investment for the user's selected portfolio. These predictions are statistically analyzed for accuracy and will alarm user if a selected company falls below predetermined levels (expectations). In the final step, the “buy” and “sell” signals are evaluated in order to support the user's selection. These calculations are used to maximize profit from the investment and give the user mathematically proven method for profitable stocks selections.

It will be appreciated that a system and method for improved asset valuation and guidance generation have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A system for generating an asset purchase recommendation comprising:
a processor-based electronic device configured to present material to a user;
a first non-transitory memory device holding an electronic representation of historical asset price information; and
a second non-transitory memory device linked to the first non-transitory memory device and to a processor of the processor-based electronic device, the second non-transitory memory device containing computer-executable instructions including instructions for retrieving price data for an asset covering a predetermined period of time, generating an analytical expression as a function of time that substantially matches the retrieved price data for the predetermined period of time, utilizing the analytical expression to predict a price for a selected point in time within the predetermined period of time and generating an error value representing a difference between the actual price and the predicted price at that point in time, and, if the error value is less than a predetermined threshold error value, generating a user display identifying the asset and displaying an asset purchase recommendation.

2. The system in accordance with claim 1, wherein retrieving price data for an asset covering a predetermined period of time includes retrieving one or more of open price, close price, high price and low price for the asset for a predetermined number of days.

3. The system in accordance with claim 1, wherein generating an analytical expression as a function of time that substantially matches the retrieved price data for the predetermined period of time comprises identifying wave-time series components and reconstructing an analytical forecasting model for asset price and movement vector.

4. The system in accordance with claim 1, wherein the selected point in time within the predetermined period of time is a point that was not used to generate the analytical expression.

5. The system in accordance with claim 1, wherein generating an error value representing a difference between the actual price and the predicted price at that point in time comprises identifying an error in movement direction or magnitude.

6. The system in accordance with claim 1, wherein generating a user display identifying the asset and displaying an asset purchase recommendation comprises displaying to the user a selection of assets whose error values are each less than a predetermined error value.

7. A method of a generating a recommendation display on a processor-based electronic device comprising:
retrieving price data for an asset covering a predetermined period of time;
generating an analytical expression as a function of time that substantially matches the retrieved price data for the predetermined period of time;
utilizing the analytical expression to predict a price for a selected point in time within the predetermined period of time;
generating an error value representing a difference between the actual price and the predicted price at that point in time; and
generating a user display identifying the asset and displaying an asset purchase recommendation if the error value is less than a predetermined threshold error value.

8. The method in accordance with claim 7, wherein retrieving price data for an asset covering a predetermined period of time includes retrieving one or more of open price, close price, high price and low price for the asset for a predetermined number of days.

9. The method in accordance with claim 7, wherein generating an analytical expression as a function of time that substantially matches the retrieved price data for the predetermined period of time comprises identifying wave-time series components and reconstructing an analytical forecasting model for asset price and movement vector.

10. The method in accordance with claim 7, wherein the selected point in time within the predetermined period of time is a point that was not used to generate the analytical expression.

11. The method in accordance with claim 7, wherein generating an error value representing a difference between the actual price and the predicted price at that point in time comprises identifying an error in one or both of asset price movement direction and magnitude.

12. The method in accordance with claim 7, wherein generating a user display identifying the asset and displaying an asset purchase recommendation comprises displaying to the user a selection of assets whose error values are each less than a predetermined error value.
